(19) United States
(12) Patent Application Publication
(10) Pub. No.: US 2007/0046848 A1
(43) Pub. Date: Mar. 1, 2007

(54) THIN FILM TRANSISTOR ARRAY SUBSTRATE AND REPAIRING METHOD THEREOF

(76) Inventors: Chien-Chin Jen, Taipei City (TW); Meng-Chi Liou, Taoyuan County (TW); Ming-Zen Wu, Kaohsiung County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/163,817

(22) Filed: Oct. 31, 2005

(30) Foreign Application Priority Data
Aug. 24, 2005 (TW) 94128881

(51) Int. Cl. G02F 1/1333

(52) U.S. Cl. 349/54

(57) ABSTRACT

A thin film transistor array substrate including a substrate, scan lines, data lines, common lines, thin film transistors, pixel electrode and repairing lines is provided. The scan lines and the data lines are disposed on the substrate for defining pixel regions. The common lines disposed on the substrate are substantially paralleled to one another, and the scan line is arranged between every neighboring two of the common lines. Each thin film transistor is arranged on one of the pixel regions and is electrically connected to the corresponding scan line and data line. Each pixel electrode is arranged on one of the pixel region and is electrically connected to the corresponding thin film transistor. Each repairing line is disposed below the corresponding data line, and one end of each repairing line overlaps with the thin film transistor disposed at one side of the corresponding data line.

### CROSS-REFERENCE TO RELATED APPLICATION

This application claims the priority benefit of Taiwan application serial no. 94128881, filed on Aug. 24, 2005. All disclosure of the Taiwan application is incorporated herein by reference.

### BACKGROUND OF THE INVENTION

1. Field of the Invention

The present invention generally relates to an active device array substrate and a repairing method thereof. More particularly, the present invention relates to a thin film transistor array substrate and a repairing method thereof.

2. Description of Related Art

The thin film transistor liquid crystal display (TFT-LCD) is mainly composed of a thin film transistor array substrate, a color filter array substrate and a liquid crystal layer. The thin film transistor array substrate comprises a plurality of thin film transistors arranged in a matrix and a plurality of pixel electrodes while each pixel electrode is corresponding to one of the thin film transistors. The thin film transistors serve as the switch devices of the pixel units. For control each pixel unit, a pixel unit is selected by the scan line and the data line electrically connected to the thin film transistor while an operation voltage is applied to the pixel unit, to display image data.

Although the fabrication technique of the TFT-LCD has become mature, the display panels would still have defects during the fabrication process. These defects would make the user feel uncomfortable during watching the TFT-LCD. However, if the display panels with the defects are discarded, the production cost would be higher. Generally speaking, it is hard to fabricate the TFT-LCD without any defects only by improving the fabrication process. The repairing technique for the defects formed in the LCD panel becomes very important.

### SUMMARY OF THE INVENTION

Accordingly, the present invention is directed to a thin film transistor array substrate for avoiding the abnormal display of the pixel unit due to the defects formed during the fabrication process, to provide a higher yield rate.

The present invention is also directed to a method of repairing a thin film transistor array substrate for repairing a thin film transistor array substrate with at least one defective pixel unit, so as to improve the yield rate of the thin film transistor array substrate.

As embodied and broadly described herein, the present invention provides a thin film transistor array substrate comprising a substrate, a plurality of scan lines, a plurality of data lines, a plurality of common lines, a plurality of thin film transistors, a plurality of pixel electrodes and a plurality of repairing lines. The scan lines and the data lines are arranged on the substrate to define a plurality of pixel regions arranged in a matrix on the substrate. The common lines disposed on the substrate are substantially paralleled to one another, and a scan line is arranged between every neighboring two of the common lines. Besides, the thin film transistors are respectively arranged on the pixel regions and are electrically connected to the corresponding scan lines and data lines. The pixel electrodes are respectively arranged on the pixel regions and are electrically connected to the corresponding thin film transistors. Further, the repairing lines are disposed below the corresponding data lines respectively while one end of each repairing line overlaps with the thin film transistor disposed at one side of the corresponding data line.

According to an embodiment of the present invention, the other end of each repairing line is electrically connected to the common line disposed at the other side of the corresponding data line for example.

According to an embodiment of the present invention, each common line comprises a plurality of branches outward extended from two sides of each common line, the branches are next to the data lines, and the other end of each repairing line is electrically connected to one of the branches of the common line disposed at the other side of the corresponding data line.

According to an embodiment of the present invention, each repairing line overlaps with a drain of the corresponding thin film transistor.

According to an embodiment of the present invention, the scan lines, the common lines and the repairing lines are the same film layer. The film layer can be a metal layer for example.

According to an embodiment of the present invention, a material of the pixel electrodes comprises a transparent conductive material. The transparent conductive material comprises indium tin oxide or indium zinc oxide.

According to an embodiment of the present invention, each thin film transistor comprises a gate, a source, a drain and a semiconductor layer. The gate is electrically connected to the corresponding scan line. The source is electrically connected to the corresponding data line. The drain is electrically connected to the corresponding pixel electrode. The semiconductor layer is disposed between the gate and the source and drain.

According to an embodiment of the present invention, each semiconductor layer comprises a channel layer and an ohmic contact layer disposed thereon.

As embodied and broadly described herein, the present invention provides a method of repairing a thin film transistor array substrate suitable for repairing the above mentioned thin film transistor array substrate. The above mentioned thin film transistor array substrate comprises a defective thin film transistor such that the pixel region, where the defective thin film transistor is disposed, is a defective pixel region. The method comprises the steps of electrically connecting the repairing line of the defective pixel region and the data line disposed thereon, and electrically connecting the repairing line of the defective pixel region and the pixel electrode in the defective pixel region.

According to an embodiment of the present invention, the other end of each repairing line of the thin film transistor array substrate is electrically connected to the common line disposed at the other side of the corresponding data line for example; the method further comprises the step of separating the repairing line of the defective pixel region from the common line electrically connected thereto.

According to an embodiment of the present invention, the method for separating the repairing line of the defective pixel region from the common line electrically connected thereto comprises laser cutting.

According to an embodiment of the present invention, the method for electrically connecting the repairing line of the defective pixel region and the data line disposed thereon comprises laser welding.

According to an embodiment of the present invention, the defective thin film transistor comprises a drain while the repairing line of the defective pixel region is electrically connected to the pixel electrode of the defective pixel region through the drain for example.

According to an embodiment of the present invention, the method for electrically connecting the repairing line of the defective pixel region and the drain of the defective thin film transistor comprises laser welding.

The thin film transistor array substrate comprises a plurality of repairing lines respectively arranged below the corresponding data lines, and one end of each repairing line overlaps with the thin film transistor disposed at one side of the corresponding data line. If the thin film transistor array substrate comprises a defective thin film transistor, the user only needs to electrically connect one end of the repairing line corresponding to the defective pixel region and the defective thin film transistor, and electrically connect the other end of the repairing line and the data line disposed above the repairing line. The method of repairing a thin film transistor of the present invention is simpler, and the manufacturing time and production cost can be reduced.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a top view showing a thin film transistor array substrate according to one embodiment of the present invention.

FIG. 2 is a schematic diagram showing how to repair the thin film transistor array substrate according to one embodiment of the present invention.

FIG. 3 is a flow chart showing a method of repairing a thin film transistor array according to an embodiment of the present invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

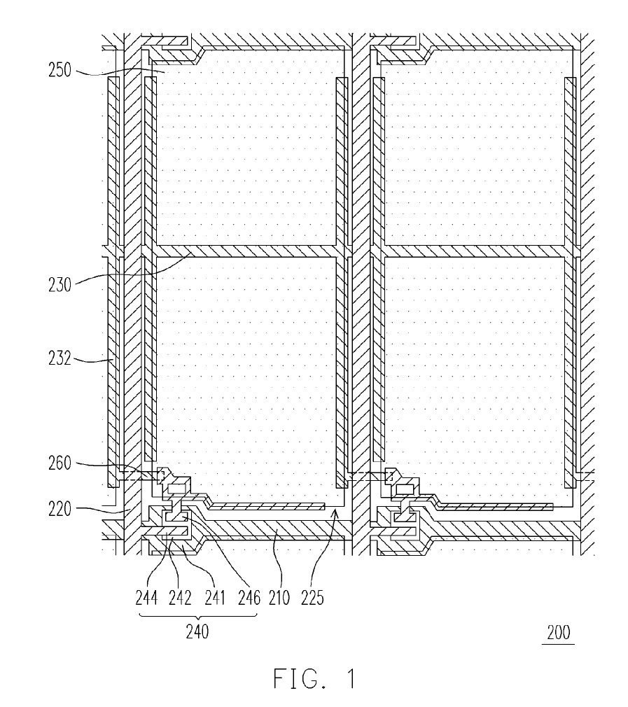

FIG. 1 is a top view showing a thin film transistor array substrate according to one embodiment of the present invention. Please refer to FIG. 1, a thin film transistor array substrate 200 of the present invention comprises a substrate (not shown), a plurality of scan lines 210, a plurality of data lines 220, a plurality of common lines 230, a plurality of thin film transistors 240, a plurality of pixel electrodes 250 and a plurality of repairing lines 260. The scan lines 220 and the data lines 230 are arranged on the substrate to define a plurality of pixel regions 225 arranged in a matrix on the substrate. The common lines 230 are disposed on the substrate and substantially paralleled to one another, and a scan line 210 is arranged between every neighboring two of the common lines 230. Besides, the thin film transistors 240 are respectively arranged on the pixel regions 225 and each thin film transistor 240 is electrically connected to the corresponding scan line 210 and data line 220. The pixel electrodes 250 are respectively arranged on the pixel regions 225 and each pixel electrode 250 is electrically connected to the corresponding thin film transistor 240. Further, the repairing lines 260 are disposed below the corresponding data lines 220 respectively while one end of each repairing line 260 overlaps with the thin film transistor 240 disposed at one side of the corresponding data line 220.

In the above mentioned thin film transistor array substrate 200, the substrate is a glass substrate while the thin film transistor 240 comprises a gate 241, a semiconductor layer 242, a source 244 and a drain 246 for example. The gate 241 is electrically connected to the scan line 210 and the semiconductor layer 242 is disposed above the gate 241. In one embodiment, the semiconductor layer 242 comprises a channel layer (not shown) and an ohm contact layer (not shown) disposed thereon. The source 244 and the drain 246 are disposed on the semiconductor layer 242 which is disposed above the gate 241, and are electrically connected to the corresponding data line 220 and the pixel electrode 250 respectively. Besides, the repairing line 260 overlaps with the drain 246 of the corresponding thin film transistor 240 for example.

In this embodiment, the gate 241, the scan lines 210, the common lines 230 and the repairing lines 260 are formed simultaneously for example. It means that the gate 241, the scan lines 210, the common lines 230 and the repairing lines 260 are the same film layer (like metal layer). Therefore, no extra time is required to form the repairing lines 260, such that the manufacturing time and production cost can be reduced. Besides, the material of the pixel electrode 250 can be indium tin oxide (ITO), indium zinc oxide (IZO) or other transparent or opaque conductive material for example.

Because the repairing lines 260 are in a floating state, an electrostatic discharge (ESD) easily occurs to damage the devices. In this embodiment, the other end of the repairing line 260 is electrically connected to the common line 230 disposed at the other side of the corresponding data line 220, so as to stabilize the voltage and further avoid the occurrence of ESD in the repairing lines 260. In a preferred embodiment, each common line 230 comprises a plurality of branches 232 outward extended from two sides of each common line for example, the branches 232 are next to the data lines 230, and the other end of each repairing line 260 is electrically connected to one of the branches 232 of the common line 230 disposed at the other side of the corresponding data line 220.

The thin film transistor array substrate 220 comprises a plurality of repairing lines 260. When the thin film transistor array substrate 200 has a defective pixel region, the repairing line 260 is adapted to repair the pixel. The method of repairing the thin film transistor array substrate is illustrated in the following.

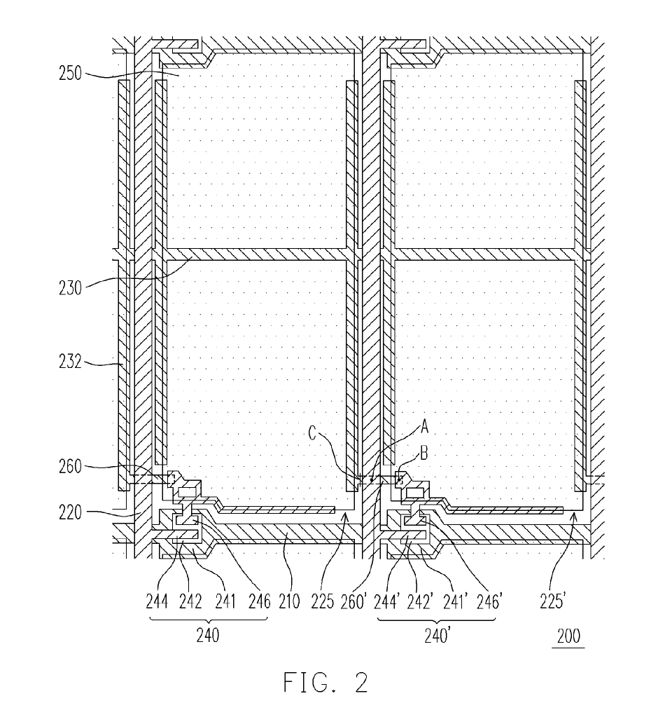

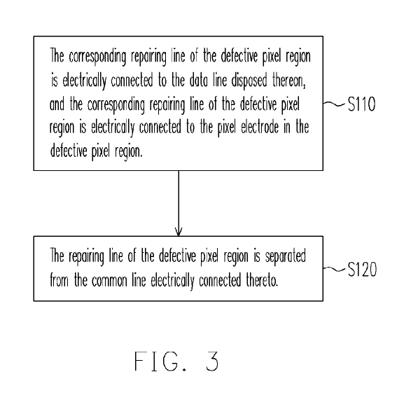

FIG. 2 is a schematic diagram showing how to repair the thin film transistor array substrate according to one embodiment of the present invention. FIG. 3 is a flow chart showing a method of repairing a thin film transistor array according to an embodiment of the present invention. Please refer to FIGS. 2 and 3, when fabricating a thin film transistor array substrate, a few thin film transistors would have defects because of the defects happened in the fabrication process or other factors, so as to make the thin film transistors fail. During the fabrication process of the thin film transistor array substrate, the step of dry etching utilizes plasma to bombard the gas molecules, so as to make the gas molecules become charge separation, and the charges are easily accumulated. After a period of time, these charges are gathered and accumulated, and they could penetrate through the deposited metal layer and make a short circuit occur between the gate 241′ and the source 244′/drain 246′. The thin film transistor 240′ is out of order and make the pixel unit where the thin film transistor 240′ is located be unable to display, so as to display a white spot (or a dark spot) in the LCD. In this embodiment, the method of repairing the thin film transistor array substrate is adapted to repair the defective thin film transistor 240′.

The method of repairing the thin film transistor array substrate is to electrically connect the corresponding repairing line 260′ of the defective pixel region 225′ and the data line 230 disposed thereon, and electrically connect the corresponding repairing line 260′ of the defective pixel region 225′ and the pixel electrode 250 in the defective pixel region 225′ (as shown in step S110). Besides, if the other end of each repairing line 260 of the thin film transistor array substrate 200 is electrically connected to the common line 230 disposed at the other side of the corresponding data line 220; the method further comprising the step of separating the repairing line 260′ of the defective pixel region 225′ from the common line 230 electrically connected thereto (as shown in step S120).

More specifically, a laser beam is focused on the point A and B from the front or the back of the thin film transistor array substrate 200 by laser welding, so as to electrically connect the corresponding repairing line 260′ of the defective pixel region 225′ and the data line 220 disposed thereon, and to electrically connect the repairing line 260′ and the drain 246′ of the defective thin film transistor 240′. The repairing line 260′ is electrically connected to the pixel electrode 250 of the defective pixel region 225′ through the drain 246′ of the defective thin film transistor 240′. Further, the repairing line 260′ is cut along the path C by laser, so as to separate the repairing line 260′ from the branch 232 of the common line 230 electrically connected thereto.

After the repairing line 260′ is electrically connected to the data line 230 thereon and the drain 242′ of the defective thin film transistor 240′, the signal transmitted from the data line 220 can be transmitted to the pixel unit where the thin film transistor 240 is located through the repairing line 260′, to make the pixel unit display normally.

In summary, the thin film transistor array substrate and repairing method thereof according to the present invention comprise the following advantages:

1. Because the repairing lines, the gates, the scan lines and the common lines are formed simultaneously, and therefore no extra time is required to form the repairing line, such that the manufacturing time and production cost can be reduced.

2. Because the method of repairing the thin film transistor is simpler, the time for repairing the pixel can be reduced, so as to reduce the production cost.

3. Each repairing line is disposed outside the display region, such that the pixel can be repaired under the condition that the aperture ratio of the pixel would not be reduced.

It will be apparent to those skilled in the art that various modifications and variations may be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A thin film transistor array substrate, comprising:
a substrate;
a plurality of scan lines arranged on the substrate;
a plurality of data lines arranged on the substrate, wherein the scan lines and the data lines are adapted to define a plurality of pixel regions arranged in a matrix on the substrate;
a plurality of common lines disposed on the substrate and substantially paralleled to one another, and a scan line arranged between every neighboring two of the common lines;
a plurality of thin film transistors arranged on the pixel regions respectively, wherein each thin film transistor is electrically connected to the corresponding scan line and data line;
a plurality of pixel electrodes arranged on the pixel regions respectively, wherein each pixel electrode is electrically connected to the corresponding thin film transistor; and
a plurality of repairing lines disposed below the corresponding data lines respectively, wherein one end of each repairing line overlaps with the thin film transistor disposed at one side of the corresponding data line.

2. The thin film transistor array substrate according to claim 1, wherein the other end of each repairing line is electrically connected to the common line disposed at the other side of the corresponding data line.

3. The thin film transistor array substrate according to claim 1, wherein each common line comprises a plurality of branches outward extended from two sides of each common line, the branches are next to the data lines, and the other end of each repairing line is electrically connected to one of the branches of the common line disposed at the other side of the corresponding data line.

4. The thin film transistor array substrate according to claim 1, wherein each repairing line overlaps with a drain of the corresponding thin film transistor.

5. The thin film transistor array substrate according to claim 1, wherein the scan lines, the common lines and the repairing lines are the same film layer.

6. The thin film transistor array substrate according to claim 5, wherein the film layer comprises a metal layer.

7. The thin film transistor array substrate according to claim 1, wherein a material of the pixel electrodes comprises a transparent conductive material.

8. The thin film transistor array substrate according to claim 7, wherein the transparent conductive material comprises indium tin oxide or indium zinc oxide.

9. The thin film transistor array substrate according to claim 7, wherein each thin film transistor comprises:
a gate electrically connected to the corresponding scan line;
a source electrically connected to the corresponding data line;
a drain electrically connected to the corresponding pixel electrode; and
a semiconductor layer disposed between the gate and the source and drain.

10. The thin film transistor array substrate according to claim 9, wherein each semiconductor layer comprises:
a channel layer; and
an ohmic contact layer disposed on the channel layer.

11. A method of repairing a thin film transistor array substrate suitable for repairing a thin film transistor array substrate as recited in claim 1, wherein the thin film transistor array substrate comprises a defective thin film transistor such that the pixel region, where the defective thin film transistor is disposed, is a defective pixel region; the method comprising: electrically connecting the repairing line of the defective pixel region and the data line disposed thereon, and electrically connecting the repairing line of the defective pixel region and the pixel electrode in the defective pixel region.

12. The method of repairing a thin film transistor array substrate according to claim 11, wherein the other end of each repairing line of the thin film transistor array substrate is electrically connected to the common line disposed at the other side of the corresponding data line; the method further comprising: separating the repairing line of the defective pixel region from the common line electrically connected thereto.

13. The method of repairing a thin film transistor array substrate according to claim 12, wherein the method for separating the repairing line of the defective pixel region from the common line connected thereto comprises laser cutting.

14. The method of repairing a thin film transistor array substrate according to claim 11, wherein the method for electrically connecting the repairing line of the defective pixel region and the data line disposed thereon comprises laser welding.

15. The method of repairing a thin film transistor array substrate according to claim 11, wherein the defective thin film transistor comprises a drain and the repairing line of the defective pixel region is electrically connected to the pixel electrode of the defective pixel region through the drain.

16. The method of repairing a thin film transistor array substrate according to claim 15, wherein the method for electrically connecting the repairing line of the defective pixel region and the drain of the defective thin film transistor comprises laser welding.
